(19) United States
(12) Patent Application Publication
(10) Pub. No.: US 2008/0117180 A1
(43) Pub. Date: May 22, 2008

(54) IMAGE FORMING APPARATUS AND FACSIMILE APPARATUS

(75) Inventor: Kouichi MOTOYOSHI, Kyoto-shi (JP)

Correspondence Address: MURATA MACHINERY, LTD.;(MURATEC) c/o KEATING & BENNETT LLP, 8180 GREENSBORO DRIVE, SUITE 850, MCLEAN, VA, 22102, US

(73) Assignee: MURATA MACHINERY, LTD., Fushimi-ku (JP)

(21) Appl. No.: 11/923,877

(22) Filed: Oct. 25, 2007

(30) Foreign Application Priority Data
Nov. 16, 2006 (JP) 2006-310224

(51) Int. Cl. G06F 3/041

(52) U.S. Cl. 345/173; 345/82

(57) ABSTRACT

A copy and facsimile multifunction peripheral includes an operating unit on the top of a housing on the front side thereof. The operating unit includes a dot matrix display composed of light-emitting elements, a light-transmissive display unit cover that covers a display area of the dot matrix display and constitutes a portion of the contour of the upper surface of the housing, and a transparent touch panel sheet arranged on the surface of the display unit cover so as to cover at least a portion of the display area of the dot matrix display. An operation control unit provided in the copy and facsimile multifunction peripheral displays a predetermined pattern on the dot matrix display and, when the touch panel sheet senses a touch on the pattern display area, controls the apparatus to carry out the operation corresponding to the pattern.

### CROSS-REFERENCE TO RELATED APPLICATIONS

This application claims priority under 35 U.S.C 119 to Japanese Patent Application No. 2006-310224, filed on Nov. 16, 2006, which application is hereby incorporated by reference in its entirety.

### BACKGROUND OF THE INVENTION

1. Field of the Invention

The present invention relates to a configuration of an image forming apparatus for forming images by operating a control panel.

2. Description of the Related Art

A copying machine disclosed in JP-A-2005-122450 includes an operation input unit which displays a setting status, an operating guide, and so on of the copying machine and allows the user to operate for inputting instructions or the like. The operation input unit includes a display panel composed of a liquid crystal panel, a touch panel overlaid thereon, and a key input unit including a plurality of operating keys.

However, in the configuration described above, a number of buttons or keys are arranged on the operating unit. Therefore, the appearance is complicated, and in many cases, it gives the user the impression that it is difficult to operate.

### SUMMARY OF THE INVENTION

In order to overcome the problems described above, preferred embodiments of the present invention provide a simple design of a control unit that provides users a fresh operation feeling associated with the impression of being easy to operate.

According to a preferred embodiment of the present invention, an image forming apparatus includes an operating unit on the upper surface of a housing on the front side of the apparatus and an operation control unit arranged to control the operation of the apparatus according to an operation of the operating unit. The operating unit preferably includes a dot matrix display including light-emitting diodes, a light-transmissive display unit cover that covers a display area of the dot matrix display and constitutes at least a portion of the contour of the upper surface of the housing, and a transparent touch panel sheet provided on a surface of the display unit cover so as to cover at least a portion of the display area of the dot matrix display. The operation control unit displays patterns on the dot matrix display and, when the touch panel sheet senses a touch on the pattern display area, controls the apparatus to carry out the operation corresponding to the touched pattern.

In this configuration, instructions for the operation of the apparatus can be given simply by touching the pattern displayed on the display unit cover on the top of the housing via the dot matrix display. Since the display unit cover constitutes the contour of the upper surface of the housing, the impression that the operating unit is integrated with the upper surface of the housing is given in appearance. Therefore, a simple, direct, and fresh operating feeling is provided to the user as if he/she gives an operating instruction not via the independent operating unit, but directly to the apparatus itself.

The image forming apparatus described above is preferably configured in such a manner that the operating unit is not provided with a button having a configuration to be pushed in by the operating force of the user.

In this configuration, the impression that the operation is complicated and difficult is not given to the user, and a simple and user-friendly operating feeling is realized. Since buttons are eliminated, the appearance is simplified by reducing projections and depressions on the operating unit to the maximum, so that the apparatus is easily reduced in size.

The image forming apparatus described above is preferably configured in such a manner that it includes a microphone for voice input. The operation control unit controls the apparatus to recognize a voice entered through the microphone and carry out the operation corresponding to the result of the voice recognition.

In this configuration, the voice operation of the image forming apparatus is enabled, so that the ease of operation is further improved. It is also possible to selectively switch the operation between the operation through the touch on the touch panel sheet and the voice operation through the microphone according to the content of the operation.

The image forming apparatus described above is preferably configured in such a manner that the display unit cover is formed with speaker holes at the side(s) of the position corresponding to the dot matrix display. A speaker(s) for voice output is provided at the position corresponding to the speaker holes. The operation control unit outputs guide voice from the speaker in the mode of the voice input operation through the microphone.

In this configuration, since the user is able to carry out the voice operation by following a guide voice (a navigation voice) from the speaker, the voice operation is further facilitated. Since the voice outputted from the speaker is propagated through the speaker holes formed on the display unit cover to the outside, the user who is operating the image forming apparatus can hear the guide voice clearly.

The image forming apparatus is preferably configured in such a manner that the operation control unit displays a predetermined pattern on the dot matrix display in the mode of the voice input operation through the microphone. When the touch panel sheet senses the touch on the pattern display area, the voice input operation is stopped, and the pattern corresponding to the voice input operation is displayed on the dot matrix display to switch the input operation to the operation through the touch panel sheet.

In this configuration, in a circumstance in which the voice operation is difficult due to the noise in the environment, the mode of operation can be switched easily to the operation through the touch panel sheet. Therefore, the apparatus can be operated with flexibility, and the user-friendliness is further improved.

According to another preferred embodiment of the present invention, a facsimile apparatus as the image forming apparatus is provided.

Other features, elements, processes, steps, characteristics, and advantages of the present invention will become more apparent from the following detailed description of preferred embodiments of the present invention with reference to the attached drawings.

### BRIEF DESCRIPTION OF DRAWINGS

FIG. 1 is a perspective view showing a general configuration of a copy and facsimile multifunction peripheral according to a preferred embodiment of the present invention.

FIG. 2 is a perspective view showing a state in which respective covers are rotated and opened from a state in FIG. 1.

FIG. 3 is a block diagram showing an electrical configuration for controlling an operating unit.

### DETAILED DESCRIPTION OF PREFERRED EMBODIMENTS

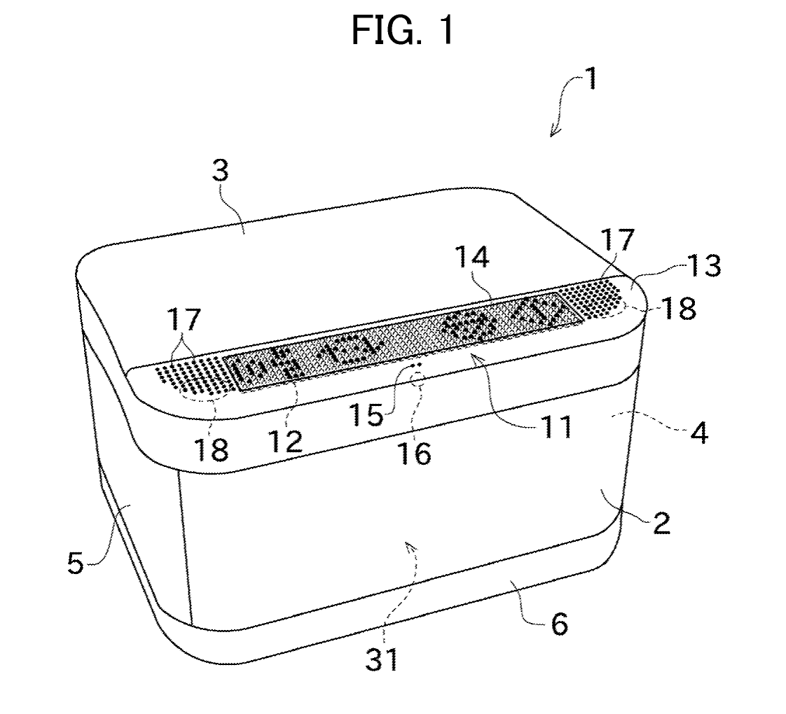

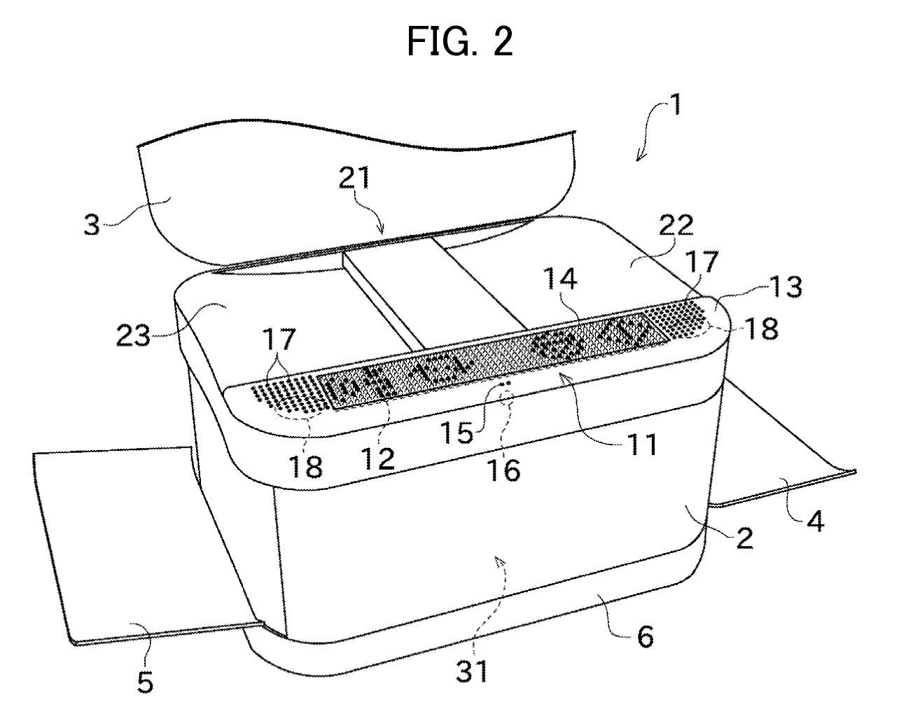

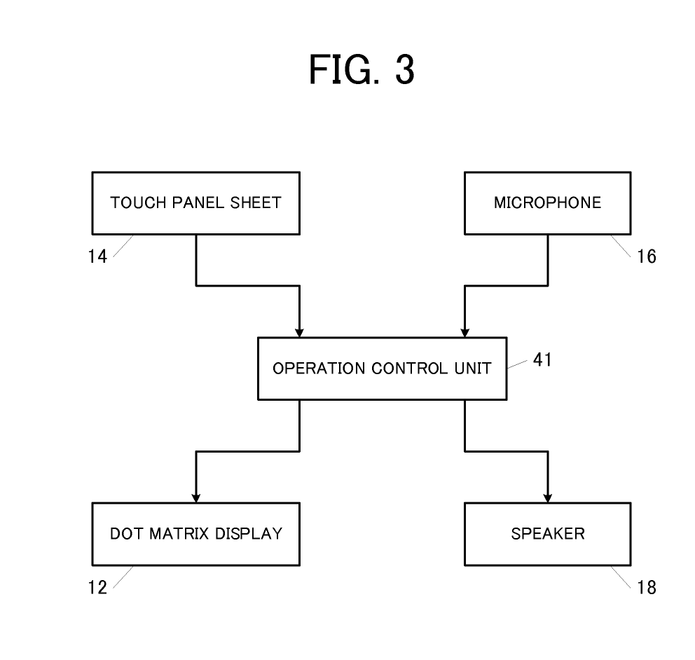

Preferred embodiments of the present invention will be described below with reference to the figures. FIG. 1 is a perspective view illustrating a general configuration of a copy and facsimile multifunction peripheral according to a preferred embodiment of the present invention; FIG. 2 is a perspective view illustrating a state in which covers are rotated and opened from a state in FIG. 1; and FIG. 3 is a block diagram illustrating a electrical configuration for controlling an operating unit.

A copy and facsimile multifunction peripheral 1 as an image forming apparatus and a facsimile apparatus illustrated in FIG. 1 includes a housing 2 preferably having a substantially rectangular parallelepiped shape, a scanner cover (top cover) 3 supported on the top of the housing 2 so as to be capable of opening and closing, a manual feed tray cover (side cover) 4 supported on one side surface of the housing 2 so as to be capable of opening and closing, a paper discharge cover (side cover) 5 supported on the other side surface of the housing 2 so as to be capable of opening and closing. Provided on the front side of the top of the housing 2 is an operating unit 11 for performing various operations with respect to the copy and facsimile multifunction peripheral 1.

FIG. 2 illustrates a state in which the scanner cover 3, the manual feed tray cover 4 and the paper discharge cover 5 are opened, respectively. As shown in FIG. 2, the housing 2 is provided with an image reading unit 21 on the upper portion thereof. The image reading unit 21 is provided with an original tray 22 on which a read original can be set, and a discharge tray 23 for discharge of the original fed from the original tray 22 with the content being read by a scanner unit (not illustrated). The image reading unit 21 is configured to be protected from the outside in a state in which the scanner cover 3 is closed (FIG. 1) when not in use.

The housing 2 is provided with a paper feed tray 6 on the lower portion thereof, so that a sheet as a recording medium set on the paper feed tray 6 or a sheet set on the manual feed tray cover 4 is fed to an image forming unit 31 in the housing 2. The image forming unit 31 is configured to be able to form an image of the content of an original read by the image reading unit 21 or the content that is received through facsimile on a fed sheet and discharge the sheet onto the paper discharge cover 5.

The operating unit 11 for giving instructions for the operation to the image reading unit 21 and the image forming unit 31 includes a dot matrix display 12 having light-emitting diodes (LEDs) as light-emitting elements arranged in a matrix pattern, a display unit cover 13 arranged so as to cover the upper side of the dot matrix display 12, and an operation control unit (touch panel sheet) 14 adhered on a surface (upper surface) of the display unit cover 13.

The dot matrix display 12 includes a number of LEDs arranged in rows and columns, and is configured to display predetermined information such as characters and signs by causing these LED groups to emit light in predetermined patterns. The display unit cover 13 is preferably composed of transparent resin or solid thin film resin, and is configured to allow the user to recognize emitted light from the dot matrix display 12 provided below from above owing to its light-transmitting property. Furthermore, the display unit cover 13 constitutes a part of the contour of the upper surface of the housing 2 and, in the state in which the scanner cover 3 is closed as in FIG. 1, the scanner cover 3 and the display unit cover 13 form a flat contour having no level difference. That is, the scanner cover 3 and the display unit cover 13 are flush with each other and define a continuous, flat surface.

The touch panel sheet 14 is adhered to the surface of the display unit cover 13 so as to cover substantially the entire portion of the display area of the dot matrix display 12. With respect to the adhered portion, the display unit cover 13 is formed with a recess having a thickness corresponding to the thickness of the touch panel sheet 14 on the surface thereof, and the touch panel sheet 14 is attached to the recess. Consequently, any level difference between the surface of the touch panel sheet 14 and the surface of the display unit cover 13 is prevented. As the touch panel sheet 14 is transparent, the light-emitting display on the dot matrix display 12 can be recognized from above the touch panel sheet 14.

The display unit cover 13 is preferably formed with microphone holes 15 extending therethrough on the front side of the apparatus with respect to the touch panel sheet 14. A microphone 16 for voice input is provided in the housing 2 at a position corresponding to the microphone holes 15.

The display unit cover 13 also preferably includes speaker holes 17 extending therethrough on both left and right sides of the touch panel sheet 14. Speakers 18 for voice output are provided in the housing 2 at positions corresponding to the speaker holes 17.

Referring now to FIG. 3, an electrical configuration of the operating unit 11 of the copy and facsimile multifunction peripheral 1 will be described. The operating unit 11 includes an operation control unit 41 for controlling the respective units. The operation control unit 41 is preferably configured as a known microcomputer and includes a CPU as a computing device, and a ROM and a RAM as a storage device.

The touch panel sheet 14 is connected to the operation control unit 41, and is configured to be able to transmit whether the touch panel sheet 14 is touched or not, or information on the touched position, to the operation control unit 41. The microphone 16 is also connected to the operation control unit 41, so that entered voice signals are transmitted to the operation control unit 41.

The operation control unit 41 is connected to the dot matrix display 12, and is configured to control the light-emitting pattern of the dot matrix display 12. The operation control unit 41 is connected to the speakers 18, and is configured to control the voice output from the speakers 18.

In this configuration, the operation control unit 41 transmits display control signals to the dot matrix display 12, causes specific LEDs of the dot matrix display 12 to emit light, and displays a plurality of predetermined patterns arranged in a row as illustrated in FIG. 1 and FIG. 2. These patterns correspond to various operations such as starting copying operation, setting up the density of copy, starting facsimile transmission, or setting up dial numbers of facsimile destinations. The patterns displayed on the dot matrix display 12 are arbitrary, and may be displayed in various patterns such as small drawings (icons), characters, signs, and those similar to operation buttons.

When a user touches a pattern corresponding to the desired operation with his/her finger, the touch panel sheet 14 senses the touch, and transmits information on the position touched by the finger (touched position) to the operation control unit 41. The operation control unit 41 recognizes the pattern corresponding to the touched position by inspecting which pattern on the dot matrix display 12 includes the touched position on its displayed area. Then, the operation control unit 41 gives an instruction to carry out the operation corresponding to the pattern, to the image reading unit 21, the image forming unit 31 or a facsimile transmission unit(not illustrated), as needed.

On the other hand, the user is also able to operate the copy and facsimile multifunction peripheral 1 by speaking a predetermined phrase toward the microphone 16 provided on the front surface of the apparatus instead of touching the touch panel sheet 14 with his/her finger. For example, when the user says “Dial Number Registration” toward the microphone, the operation control unit 41 recognizes the voice with a known algorithm, so that the fact that the operation that the user intends to do is a registration of dial numbers of destinations of facsimile transmission is determined.

Then, the operation control unit 41 outputs a guide voice (navigation voice) such as “Please input dial number” from the speakers 18. The user follows the voice, and speaks the dial number toward the microphone 16. The operation control unit 41 converts the voice to numerical data through voice input processing, and stores the data as dial information in RAM or the like, which is not illustrated in the drawing.

With the procedure described above, the copy and facsimile multifunction peripheral 1 can be operated with voice, and hence the operation is further facilitated. It is also possible to select the method of operation adequately according to the content of the operation in such a manner that the voice operation is used for the operations, such as registration of a dial number, which the user can redo, and the touch operation of the touch panel sheet 14 is used for the operations—such as the facsimile transmission—which the user cannot redo.

The voice operation as described above demonstrates a sufficiently effective function in a quiet environment in the room. However, there are cases where the voice operation cannot be used easily, for example, when the environment around the copy and facsimile multifunction peripheral 1 is very noisy, or when the environment is not suitable for speaking loudly and clearly.

In view of such circumstances, in this preferred embodiment, the operation control unit 41 displays a specific pattern (a pattern for allowing the user to switch the input mode to the input through the touch panel sheet 14) on the dot matrix display 12 in the mode of the voice input operation using the microphone 16. Then, when the touch panel sheet 14 senses that the user touches the pattern on the display area, the operation control unit 41 stops the voice input operation, displays a pattern with numeric characters such as “1234567890” on the dot matrix display 12, and switches the input mode to the dial number input mode using the touch panel sheet 14, thereby allowing the user to input, for example, the number “4” by touching the pattern of “4”. With this control, various operating methods are provided according to the various environments, and ease of operation of the copy and facsimile multifunction peripheral 1 is improved.

As described above, the copy and facsimile multifunction peripheral 1 in this preferred embodiment is preferably provided with the operating unit 11 on the top of the housing 2 on the front side of the apparatus, and the operation control unit 41 that controls the operation of the copy and facsimile multifunction peripheral 1 according to the operation of the operating unit 11. The operating unit 11 includes the dot matrix display 12 preferably composed of the light-emitting diodes, the light-transmissive display unit cover 13 that covers the display area of the dot matrix display 12 and constitutes the contour of the upper surface of the housing 2 on the front side of the apparatus, and the transparent touch panel sheet 14 provided on the surface of the display unit cover 13 so as to cover the display area of the dot matrix display 12. The operation control unit 41 controls the apparatus to display the pattern on the dot matrix display 12 and, when the touch panel sheet 14 senses a touch on the pattern display area, carry out the operation corresponding to the touched pattern.

Accordingly, instructions for the operation of the apparatus are given to the apparatus easily by touching a pattern displayed on the display unit cover 13 on the top of the housing 2 by the dot matrix display 12 with a finger. Since the display unit cover 13 constitutes the contour of the upper surface of the housing 2, the impression that the operating unit 11 is integrated in the upper surface of the housing 2 is given in appearance. Therefore, a simple, direct, and fresh operating feeling is provided to the user as if he/she gives the operating instruction not via the independent operating unit, but directly to the apparatus itself.

The operating unit 11 in this preferred embodiment is not provided with a button (key) or buttons having a configuration to be pushed in by an operating force of the user.

In this configuration, the impression that the operation is complicated and difficult is not given to the user, and a simple and user-friendly operating feeling is realized. Since the button (key) is eliminated, the appearance is simplified by reducing projections and depressions on the operating unit 11 to the maximum, so that the apparatus easily reduced in size.

The operating unit 11 in this preferred embodiment is preferably provided with the microphone 16 for voice input, and the operation control unit 41 controls the apparatus to recognize a voice entered through the microphone 16 and carries out the operation corresponding to the result of recognition.

In this configuration, the voice operation of the copy and facsimile multifunction peripheral 1 is achieved, so that the ease of operation is further improved. It is also possible to selectively switch the operation between the operation through the touch on the touch panel sheet 14 and the voice operation through the microphone 16 according to the content of the operation.

In this preferred embodiment, the display unit cover 13 preferably includes speaker holes 17 at the sides of the position corresponding to the dot matrix display 12, and the speakers 18 for voice output are provided at positions corresponding to the speaker holes 17. The operation control unit 41 outputs guide voice from the speakers 18 in the mode of the voice input operation through the microphone 16.

Accordingly, since the user is able to carry out the voice operation by following a guide voice from the speakers 18, the voice operation is further facilitated. Since the voice outputted from the speakers 18 is propagated through the speaker holes 17 preferably provided on the display unit cover 13 to the outside, the user who is operating the copy and facsimile multifunction peripheral 1 can hear the guide voice clearly.

The operation control unit 41 in this preferred embodiment controls the apparatus to display a predetermined pattern (a pattern for switching the operation to the touch operation through the touch panel sheet 14) on the dot matrix display 12 in the mode of the voice input operation for entering, for example, the dial number, through the microphone 16. Then, when the touch panel sheet 14 senses a touch on the pattern display area, the voice input operation is stopped, and the pattern corresponding to the voice input operation (numeric characters “1234567890”) is displayed on the dot matrix display 12 to switch the input operation to the operation through the touch panel sheet 14.

Accordingly, in a circumstance in which the voice operation is difficult due to the noise in the environment, the mode of operation can be switched easily to the operation through the touch panel sheet 14. Therefore, the apparatus can be operated with flexibility, and the user-friendliness is further improved.

A preferred embodiment of the present invention has been described thus far, the configuration illustrated above may be modified, for example, as follows.

The position, shape and size of the dot matrix display 12 may be changed as needed. The touch panel sheet 14 may be provided so as to cover only a portion of the display area of the dot matrix display 12 instead of covering the entire display area of the dot matrix display 12. It is also possible to arrange an electrostatic capacitance displacement meter which functions as a sensor by measuring displacement of the electrostatic capacity instead of the touch panel sheet.

The microphone 16 may be arranged, for example, in the vicinity of the speaker 18 on one side instead of the center of the display unit cover 13 on the front side of the apparatus. In this case, the microphone holes 15 may be omitted. The microphone 16 and the microphone holes 15 may also be arranged on the front surface (front face) of the housing 2 instead of the upper surface of the housing 2. The speakers 18 and the speaker holes 17 may be arranged, for example, on the front surface or the side surface of the housing 2.

The speakers 18 may be controlled to output various sounds such as a guide voice or an alarm buzzer during the operation of the touch panel sheet 14. The dot matrix display 12 is controlled so as to display various contents such as the state of the apparatus or navigating phrases for guiding the operation in addition to displaying a pattern for operation by the touch panel sheet 14.

The configuration of the preferred embodiment illustrated above is not limited to the copy and facsimile multifunction peripheral 1. For example, it is also applicable to a copying machine or a printer in which stop of the printing operation, scaling, the number of copies or prints, selection of the sheet tray, and the density of printing can be operated and set on the operating unit.

While the present invention has been described with respect to preferred embodiments thereof, it will be apparent to those skilled in the art that the disclosed invention may be modified in numerous ways and may assume many embodiments other than those specifically set out and described above. Accordingly, it is intended by the appended claims to cover all modifications of the present invention that fall within the true spirit and scope of the present invention.

What is claimed is:

1. An image forming apparatus comprising:
a housing;
an operating unit including:
a dot matrix display provided on an upper surface of the housing on a front side and including a light-emitting element;
a light-transmissive display unit cover that covers a display area of the dot matrix display and constitutes at least a portion of a contour of the upper surface of the housing; and
an operation input unit provided on a surface of the display unit cover so as to cover at least a portion of the display area of the dot matrix display; and
an operation control unit that controls the operation of the apparatus according to the operation of the operating unit, displays a pattern on the dot matrix display and, when the operation input unit detects a touch on the pattern display area, controls the apparatus to carry out the operation corresponding to the touched pattern.

2. The image forming apparatus according to claim 1, wherein the light-emitting element is a light-emitting diode.

3. The image forming apparatus according to claim 2, wherein the operation input unit is a transparent touch panel sheet.

4. The image forming apparatus according to claim 2, wherein the operation input unit includes an electrostatic capacitance displacement meter.

5. The image forming apparatus according to claim 2, wherein the operating unit is not provided with a button having a configuration to be pushed in by an operating force of the user.

6. The image forming apparatus according to claim 3, wherein the display unit cover is made of transparent resin.

7. The image forming apparatus according to claim 3, wherein the display unit cover is made of solid thin film resin.

8. The image forming apparatus according to claim 3, wherein the display unit cover includes a recess having a depth corresponding to a thickness of the touch panel sheet on the surface thereof.

9. The image forming apparatus according to claim 3, wherein the display unit cover constitutes a contour of the upper surface of the housing.

10. The image forming apparatus according to claim 3, wherein the dot matrix display is arranged to display various contents including a state of the apparatus and navigation phrases for guiding the operation.

11. The image forming apparatus according to claim 3, comprising a microphone for voice input, wherein the operation control unit recognizes a voice entered through the microphone and controls the apparatus to carry out an operation corresponding to the result of voice recognition.

12. The image forming apparatus according to claim 11, wherein the apparatus selectively switches the operation between the operation through the touch on the touch panel sheet and the voice operation through the microphone according to the content of the operation.

13. The image forming apparatus according to claim 12, wherein the microphone is provided at an approximate center of the front surface of the display unit cover.

14. The image forming apparatus according to claim 13, comprising:
speaker holes provided in the display unit cover at the side of the position corresponding to the dot matrix display; and
a speaker for voice output provided at a position corresponding to the speaker holes; wherein
the operation control unit outputs a guide voice from the speaker in the mode of voice input operation via the microphone.

15. The image forming apparatus according to claim 14, wherein the speaker is arranged to output sounds including a guide voice and an alarm buzzer in the mode of touch panel sheet operation.

16. The image forming apparatus according to claim 14, wherein the speaker holes are formed through the display unit cover at positions on both left and right sides of the touch panel sheet.

17. The image forming apparatus according to claim 14, wherein the operation control unit displays a predetermined pattern on the dot matrix display unit in the mode of voice input operation via the microphone and, when the touch panel sheet senses a touch on the pattern display area, stops the voice input operation and displays a pattern corresponding to the voice input operation on the dot matrix display to switch the operation to the mode of touch panel sheet operation.

18. The image forming apparatus according to claim 1, wherein the image forming apparatus is a facsimile apparatus.
